(19) United States
(12) Patent Application Publication
(10) Pub. No.: US 2015/0322097 A1
(43) Pub. Date: Nov. 12, 2015

(54) PROCESS FOR PREPARING AN ORGANOSILANE COMPOSITION

(71) Applicant: Dow Corning Corporation, Midland, MI (US)

(72) Inventors: Michael Salvatore FERRITTO, Midland, MI (US); Lok Ming Eva LI, Midland, MI (US); Lenin James PETROFF, Bay City, MI (US); Josef T. ROIDL, Saulheim (DE); Avril E. SURGENOR, Waterloo (BE)

(21) Appl. No.: 14/796,014

(22) Filed: Jul. 10, 2015

Related U.S. Application Data
(63) Continuation-in-part of application No. 14/355,905, filed on May 2, 2014.
(60) Provisional application No. 61/610,072, filed on Mar. 13, 2012.
(60) Provisional application No. 61/555,526, filed on Nov. 4, 2011.

(51) Int. Cl. C07F 7/18; D06M 13/513

(52) U.S. Cl. CPC C07F 7/1876; C07F 7/184; D06M 13/513; D06M 2101/06

(57) ABSTRACT

A process for preparing an organosilane composition includes reacting a) an organosilane and b) a polyoxyalkylene in the presence of c) a hydrosilylation catalyst. The organosilane a) is of the formula: (R¹)₍₃₋ₙ₎(R²O)ₙSiH. R¹ is a hydrocarbon group containing 1 to 12 carbon atoms, R² is hydrogen or an alkyl group containing 1 to 6 carbon atoms, and “n” is 1, 2 or 3. The polyoxyalkylene b) is of the formula: R⁵O(CH₂CH₂O)ₐ(C₃H₆O)_{b}R⁴. In this formula, a≧0 and b≧0 with the proviso (a+b)≧1. R⁴ is hydrogen, R¹, or an acetyl group. R⁵ is a hydrocarbon group including a terminal allylic unsaturated group. A composition comprising an organosilane is also disclosed. The organosilane is of the formula: (R¹)₍₃₋ₙ₎(R²O)ₙSiR³O(CH₂CH₂O)ₐ(C₃H₆O)_{b}R⁴. Each of “n”, “a”, “b”, R¹, R² and R⁴ is as defined above. R³ is a divalent hydrocarbon group containing 2 to 12 carbon atoms.

### CROSS-REFERENCE TO RELATED APPLICATIONS

This application is a continuation-in-part of U.S. application Ser. No. 14/355,905 filed on 2 May 2014, which is the National Stage of International Patent Appl. No. PCT/US2012/062646 filed on 31 Oct. 2012, which claims priority and all advantages of U.S. Appl. No. 61/610,072 filed on 13 Mar. 2012 and U.S. Appl. No. 61/555,526 filed on 4 Nov. 2011, the contents of which are hereby incorporated by reference.

### BACKGROUND OF THE INVENTION

There is an ongoing need to develop improved composition treatments to render various surfaces more hydrophilic. Many such surfaces are naturally hydrophobic or have limited ability to absorb water or polar liquids or have these liquids wet the surface. These surfaces may include substrates such as fibers, textiles, plastics, glass, or metals. Treating the surface to render them more hydrophilic may improve properties such as moisture pick up, absorbency, surface wetting, breathability and the like. Many of the hydrophilic surface treatments are based on the physical absorption of the treatment molecules with a surface. As such, the treatments are not robust and are easily washed off or removed. Likewise, there is an ongoing need to develop improved composition treatments to render various surfaces more hydrophobic.

Thus, there is a need to identify materials that can be used to treat various surfaces to render them hydrophilic or hydrophobic. Furthermore, there is a need to identify such hydrophilic or hydrophobic materials that permanently modify a surface and more permanently bond to the surface.

### BRIEF SUMMARY OF THE INVENTION

Disclosed is a process for preparing an organosilane composition. The process includes reacting a) an organosilane and b) a polyoxyalkylene in the presence of c) a hydrosilylation catalyst. The organosilane a) is of the formula: (R¹)₍₃₋ₙ₎(R²O)ₙSiH. In this formula, R¹ is a hydrocarbon group containing 1 to 12 carbon atoms, R² is hydrogen or an alkyl group containing 1 to 6 carbon atoms, and “n” is 1, 2 or 3. The polyoxyalkylene b) is of the formula: R⁵O(CH₂CH₂O)ₐ(C₃H₆O)_{b}R⁴. In this formula, a≧0 and b≧0 with the proviso (a+b)≧1. In a first embodiment, a≧1 and “b” may vary from 0 to 30 with the proviso a≧b. In a second embodiment, “a” may vary from 0 to 30 and b≧1 with the proviso b≧a. R⁴ is hydrogen, R¹, or an acetyl group. R⁵ is a hydrocarbon group including a terminal allylic unsaturated group. In one embodiment, a gamma (“γ”) carbon atom of R⁵ includes two independently selected hydrocarbyl groups bonded thereto. In another embodiment, a beta (“β”) carbon atom of R⁵ includes a hydrocarbyl group bonded thereto. In certain embodiments, R⁵ is an unsaturated aliphatic hydrocarbon group selected from H₂C═CHC(CH₃)₂—, HC≡CC(CH₃)₂—, and HC≡CC(CH₃)₂CH₂—. In specific embodiments, R⁵ is H₂C═CHC(CH₃)₂— or H₂C═C(CH₃)CH₂—.

A composition comprising an organosilane is also disclosed. The composition can be prepared according to the aforementioned process. The organosilane is of the formula: (R¹)₍₃₋ₙ₎(R²O)ₙSiR³O(CH₂CH₂O)ₐ(C₃H₆O)_{b}R⁴. In this formula, each of “n”, “a”, “b”, R¹, R² and R⁴ is as defined above. R³ is a divalent hydrocarbon group containing 2 to 12 carbon atoms. The organosilanes (or compositions thereof) of this disclosure can improve the hydrophilicity or hydrophobicity of treated surfaces. In particular, the organosilanes, or compositions containing reaction products derived from the organosilanes, are particularly useful to treat various surfaces to render them more hydrophilic or more hydrophobic. The organosilanes and related compositions are useful to treat textiles, fibers, or hard surfaces to improve the hydrophilicity or hydrophobicity of the surface. For example, the treated surface may have improved absorbency, moisture pick up, or surface wettability properties. Furthermore, subsequent surface treatments with the organosilane compositions are more permanent than many conventional treatments.

### DETAILED DESCRIPTION OF THE INVENTION

Disclosed is a process for preparing an organosilane composition. The process includes reacting a) an organosilane and b) a polyoxyalkylene in the presence of c) a hydrosilylation catalyst. A composition comprising an organosilane is also disclosed. The composition can be prepared according to the aforementioned process. Each of the components utilized in the process are described below.

### Organosilane:

The organosilane a) of the process, which may also be referred to as “component a)”, is of the formula:

(R¹)₍₃₋ₙ₎(R²O)ₙSiH

In this formula, each R¹ is independently a hydrocarbon group containing 1 to 12 carbon atoms. Specifically, the hydrocarbon group can contain 1, 2, 3, 4, 5, 6, 7, 8, 9, 10, 11, or 12 carbon atoms or any range of values therebetween.

The hydrocarbon group may be an alkyl group, such as methyl, ethyl, propyl, butyl, pentyl or hexyl, typically methyl or ethyl, more typically methyl. The hydrocarbon group may be a cycloalkyl group, such as cyclohexyl or cycloheptyl. The hydrocarbon group may be an aryl group, such as phenyl, tolyl, or xylyl, typically phenyl. The hydrocarbon group may be an aralkyl group, such as benzyl or phenylethyl. The hydrocarbon group may also be an alkenyl group, such as vinyl, allyl, butenyl, pentenyl, hexenyl, or decenyl, typically vinyl or hexenyl. Alternatively, the hydrocarbon group may include one or more halogen atoms. Component a) can include various combinations of the same or different hydrocarbon groups.

Each R² is independently hydrogen or an alkyl group containing 1 to 6 carbon atoms. Specifically, R² can contain 1, 2, 3, 4, 5, or 6 carbon atoms or any range of values therebetween. The alkyl group may be methyl, ethyl, propyl, butyl, pentyl or hexyl, typically methyl or ethyl. Component a) can include various combinations of hydrogen and/or the same or different alkyl groups. In certain embodiments, R² is the same as R¹, e.g. each of R² and R¹ is a methyl group. In other embodiments, R² is different from R¹, e.g. R² is an ethyl group and R¹ is a methyl group

In this formula, “n” is 1, 2 or 3. As such, component a) can further be defined as having the formula:

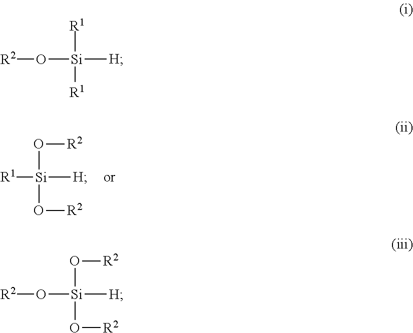

where each of R¹ and R² is as defined above. In one embodiment, component a) is formula (i) where each of R¹ and R² is methyl. In another embodiment, component a) is formula (ii) where each of R¹ and R² is methyl. In other embodiments, component a) is formula (iii) where each R² is independently methyl or ethyl. In yet another embodiment, component a) is formula (ii) where R¹ is methyl and each R² is ethyl. It is contemplated that component a) can include combinations of formulae (i), (ii) and/or (iii) with the same or differing R¹ and R² groups. In various embodiments, component a) may generally be referred to as a mono-, di-, or tri-alkoxy functional silane polyether.

Alternately, it is possible for two or more H groups to be present on the Si atom, in which case R¹ would be zero. In cases such as this, two polyether groups would subsequently be grafted onto the Si atom.

Representative examples of organosilanes suitable as component a) include, but are not limited to:
(CH₃)(CH₃CH₂O)₂SiH;
(CH₃)(CH₃O)₂SiH;
(CH₃CH₂)(CH₃CH₂O)₂SiH;
(CH₃CH₂)(CH₃O)₂SiH;
(CH₃)(HC(CH₃)₂O)₂SiH;
(CH₃CH₂O)₂SiH₂;
(CH₃O)₃SiH;
(CH₃O)₂(CH₃CH₂O)SiH;
(CH₃O)(CH₃CH₂O)₂SiH; and
(CH₃CH₂O)₃SiH.

### Polyoxyalkylene:

The polyoxyalkylene b) of the process, which may also be referred to as “component b)”, is of the formula:

R⁵O(CH₂CH₂O)ₐ(C₃H₆O)_{b}R⁴

In this formula, a≧0 and b≧0 with the proviso (a+b)≧1. Said another way, there is at least one “a” moiety (i.e., CH₂CH₂O or C₂H₄O) and/or at least one “b” moiety (i.e., C₃H₆O or CH₂CH₂CH₂O). In certain embodiments, there is at least one of each “a” and “b” moiety. In general, each of “a” and “b” may individually vary from 0-40, 1-35, 1-30, 5-25, 10-25, 15-25, or 15-20 or any range of values therebetween (provided there is at least one “a” or “b” moiety). In various embodiments, “a” can be the same as or different from “b”.

In a first embodiment, a≧1 and “b” may vary from 0 to 30 with the proviso a≧b. Specifically, “b” can be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 or any range of values therebetween. In various embodiments, “a” can be the same as or different from “b”. In certain embodiments, “a” can vary from 1 to 40. Specifically, “a” can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 or any range of values therebetween. For example, “a” may range from 4 to 30.

In a second embodiment, b≧1 and “a” may vary from 0 to 30 with the proviso b≧a. Specifically, “a” can be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 or any range of values therebetween. In various embodiments, “b” can be the same as or different from “a”. In certain embodiments, “b” can vary from 1 to 40. Specifically, “b” can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 or any range of values therebetween. For example, “b” may range from 4 to 30.

R⁴ is hydrogen, R¹, or an acetyl group (i.e., —COCH₃). Suitable R¹ groups are as defined above for component a).

R⁵ is a hydrocarbon group including a terminal allylic unsaturated group. In certain embodiments, a gamma (“γ”) carbon atom of R⁵ includes two independently selected hydrocarbyl groups bonded thereto. In other embodiments, a beta (“β”) carbon atom of R⁵ includes an independently selected hydrocarbyl group bonded thereto. In these embodiments, the hydrocarbyl groups of the γ and β carbon atoms can be the same as or different from each other, if present. Examples of suitable hydrocarbyl groups for R⁵ include the hydrocarbon groups defined for component a).

In various embodiments, R⁵ includes two independently selected alkyl groups pending from its γ carbon atom. Each of the alkyl groups may independently be methyl, ethyl, propyl, butyl, pentyl or hexyl, typically methyl or ethyl, more typically methyl. In certain embodiments, R⁵ is an unsaturated aliphatic hydrocarbon group selected from H₂C═CHC(CH₃)₂—, HC≡CC(CH₃)₂—, and HC≡CC(CH₃)₂CH₂—. In some embodiments, R⁵ is H₂C═CHCH₂—, H₂C═CHCH(CH₃)—, or H₂C═CHC(CH₃)₂—.

In various embodiments, R⁵ includes an alkyl group pending from its β carbon atom. The alkyl group may be methyl, ethyl, propyl, butyl, pentyl or hexyl, typically methyl or ethyl, more typically methyl. In certain embodiments, R⁵ is an unsaturated aliphatic hydrocarbon group selected from H₂C═C(CH₃)CH₂—, H₂C═C(CH₃)CH(CH₃)—, and H₂C═C(CH₃)C(CH₃)₂—.

In a specific embodiment, R⁵ is H₂C═CHC(CH₃)₂—, i.e., R⁵ is of the formula:

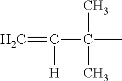

In another specific embodiment, R⁵ is H₂C═C(CH₃)CH₂—, i.e., R⁵ is of the formula:

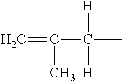

In another specific embodiment, R⁵ is H₂C═C(CH₃)CH(CH₃)—, i.e., R⁵ is of the formula:

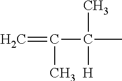

In yet another specific embodiment, R⁵ is H₂C═C(CH₃)C(CH₃)₂—, i.e., R⁵ is of the formula:

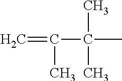

Compounds of these sorts may also be referred to in the art as methylallylic, dimethylallylic, trimethylallylic, or simply “methylallyl”, polyethers. The inventors discovered that H₂C═CHC(CH₃)₂— or H₂C═C(CH₃)CH₂— as R⁵ is especially beneficial for preparing the present organosilanes having a greater purity since this hydrocarbon group is not susceptible to rearrangements during the hydrosilylation reaction. This is especially true relative to R⁵ being H₂C═CHCH₂—, i.e., R⁵ including three pendant hydrogen atoms rather than one or more pendant methyl groups. Inhibition of isomerization can also prevent undesirable side reactions and/or undesirable by-products. This leads to improved purity without the need for any supplemental purification or other related processing steps.

In various embodiments, component b) is of the formula:

R⁵O(CH₂CH₂O)ₐ(C₃H₆O)_{b}(C₄H₈O)_{c}R⁴

In this formula, c≧0 with the proviso (a+b+c)≧1. Said another way, there is at least one “a” moiety, at least one “b” moiety, and/or at least one “c” moiety (i.e., C₄H₈O or CH₂CH₂CH₂CH₂O). In certain embodiments, there is at least one of each “a”, “b” and “c” moiety, alternatively at least one of each “a” and “c” moiety, alternatively at least one of each “b” and “c” moiety. In general, “c” may individually vary from 0-40, 1-35, 1-30, 5-25, 10-25, 15-25, or 15-20 or any range of values therebetween. For example, “c” may range from 4 to 30. Each of R⁴, R⁵, “a” and “b” is as defined above.

In various embodiments, “c” can be the same as or different from “a” and/or “b”. In certain embodiments, “c” can vary from 1 to 40. Specifically, “c” can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 or any range of values therebetween. For example, “c” may range from 4 to 30.

In general, the polyoxyalkylene useful as component b) can be any polyoxyalkylene that is terminated at one molecular chain end with an unsaturated aliphatic hydrocarbon group containing 2 to 12 carbon atoms. The polyoxyalkylene may result from the polymerization of ethylene oxide, propylene oxide, butylene oxide, 1,2-epoxyhexane, 1,2-epoxyoctance, and/or cyclic epoxides, such as cyclohexene oxide or exo-2,3-epoxynorborane.

In certain embodiments, the polyoxyalkylene group comprises predominately oxyethylene units (C₂H₄O), but may also contain minor amounts of oxypropylene units (C₃H₆O), oxybutylene units (C₄H₈O), or mixtures thereof. In other embodiments, the polyoxyalkylene group comprises predominately oxypropylene units (C₃H₆O)oxyethylene units (C₂H₄O), but may also contain minor amounts of oxyethylene units (C₂H₄O), oxybutylene units (C₄H₈O), or mixtures thereof. When the polyoxyalkylene group comprises a mixture of (C₂H₄O), (C₃H₆O), and/or (C₄H₈O) units, the oxyalkylene groups are typically randomized with the group but can also be blocked.

Polyalkyleneoxy groups (or units) may be alternatively described as alkylene oxide (AO) groups, such as an ethylene oxide (EO) groups, propylene oxide (PO) groups, butylene oxide (BO) groups, etc., or combinations thereof. In still other embodiments, examples of suitable AO groups that can be utilized include, but are not limited to, EO groups, PO groups, BO groups, amylene oxide groups, mixtures thereof, AO-tetrahydrofuran mixtures, epihalohydrins, and aralkylene styrenes, and combinations thereof. The structures of these compounds are understood by those of ordinary skill in the art.

The unsaturated aliphatic hydrocarbon group can be an alkenyl or alkynyl group. Representative, non-limiting examples of the alkenyl groups are shown by the following structures; H₂C═CH—, H₂C═CHCH₂—, H₂C═CHC(CH₃)₂—, H₂C═C(CH₃)CH₂—, H₂C═CHCH₂CH₂—, H₂C═CHCH₂CH₂CH₂—, and H₂C═CHCH₂CH₂CH₂CH₂—. Representative, non-limiting examples of alkynyl groups are shown by the following structures; HC≡C—, HC≡CCH₂—, HC≡CCH(CH₃)—, HC≡CC(CH₃)₂—, and HC≡CC(CH₃)₂CH₂—.

Polyoxyalkylenes having an unsaturated aliphatic hydrocarbon group at one molecular terminal are known in the art, and many are commercially available. Representative, non-limiting examples of polyoxyalkylenes having an unsaturated aliphatic hydrocarbyl at one molecular terminal include, but are not limited to:
H₂C═CHCH₂O[C₂H₄O]ₐH:
H₂C═CHCH₂O[C₂H₄O]ₐ[C₃H₆O]_{b}H;
H₂C═CHCH₂O[C₂H₄O]ₐCH₃;
H₂C═CHC(CH₃)₂O[C₂H₄O]ₐCH₃;
H₂C═CHC(CH₃)₂O[C₂H₄O]ₐ[C₃H₆O]_{b}H;
H₂C═CHCH₂O[C₂H₄O]ₐC(O)CH₃;
H₂C═C(CH₃)CH₂O[C₂H₄O]ₐH;
HC≡CCH₂O[C₂H₄O]ₐH; and
HC≡CC(CH₃)₂O[C₂H₄O]ₐH;
where each of “a” and “b” is as defined above.

Polyoxyalkylenes having an unsaturated aliphatic hydrocarbon group at one molecular terminal are commercially available from numerous suppliers including; NOF (Nippon Oil and Fat, Tokyo, Japan), Clariant Corp. (Switzerland), and Dow Chemical Corp. (Midland, Mich.). Commercial examples of these materials include Uniox MUS-4 from NOF, Polyglykol AM 450 from Clariant, and SF 400 and SF 443 from Dow Chemical Corp.

### Hydrosilylation Catalyst:

The hydrosilylation catalyst c) of the process, which may also be referred to as “component c)”, may be any suitable Group VIII metal based catalyst selected from a platinum, rhodium, iridium, palladium or ruthenium. Group VIII group metal containing catalysts useful to catalyze curing of the present compositions can be any of those known to catalyze reactions of silicon bonded hydrogen atoms with silicon bonded unsaturated hydrocarbon groups. Typically, the Group VIII metal for use as a catalyst to effect cure of the present compositions by hydrosilylation is a platinum based catalyst. Examples of platinum based hydrosilylation catalysts for curing the present composition are platinum metal, platinum compounds and platinum complexes.

Suitable platinum catalysts are described in U.S. Pat. No. 2,823,218 (commonly referred to as “Speier's catalyst) and U.S. Pat. No. 3,923,705. The platinum catalyst may be “Karstedt's catalyst”, which is described in Karstedt's U.S. Pat. Nos. 3,715,334 and 3,814,730. Karstedt's catalyst is a platinum divinyl tetramethyl disiloxane complex typically containing about one-weight percent of platinum in a solvent such as toluene.

Alternatively, the platinum catalyst may be a reaction product of chloroplatinic acid and an organosilicon compound containing terminal aliphatic unsaturation, as described in U.S. Pat. No. 3,419,593. Alternatively, the hydrosilylation catalyst is a neutralized complex of platinum chloride and divinyl tetramethyl disiloxane, as described in U.S. Pat. No. 5,175,325. Further suitable hydrosilylation catalysts are described in, for example, U.S. Pat. Nos. 3,159,601; 3,220,972; 3,296,291; 3,516,946; 3,989,668; 4,784,879; 5,036,117; and 5,175,325; as well as in EP 0 347 895 B1

The hydrosilylation catalyst may be added in an amount equivalent to as little as 0.001 part by weight of elemental platinum group metal, per one million parts (ppm) of the total reaction composition. Typically, the concentration of the hydrosilylation catalyst in the reaction composition is that capable of providing the equivalent of at least 1 part per million of elemental platinum group metal. A catalyst concentration providing the equivalent of about 1 to about 500, alternatively about 50 to about 500, alternatively about 50 to about 200, parts per million of elemental platinum group metal may be used.

The reaction effected in the present process is a hydrosilylation reaction, wherein a SiH group of component a) reacts with an unsaturated aliphatic hydrocarbon group of component b) to form a silicon carbon (Si—C) bond. The reaction may be conducted under those conditions known in the art for effecting hydrosilylation reactions.

### Process:

As introduced above, the organosilane may be prepared by reacting: component a) and component b) in the presence of component c). The amounts of components a) and b) used in the hydrosilylation reaction may vary. The molar ratio of the SiH units of component a) to the aliphatic unsaturated groups of component b) may range from about 10/1 to about 1/10, alternatively from about 5/1 to about 1/5, or alternatively from about 2/1 to about 1/2. Typically, the amounts of components a) and b) are selected to provide molar excess of the unsaturated groups of component b) to the SiH groups in component a). However, it is also possible that components a) and b) are reacted in a molar ratio of 1/1 to obtain a suitable yield of the organosilane.

The hydrosilylation reaction can be conducted neat or in the presence of a solvent. The solvent can be an alcohol, such as methanol, ethanol, isopropanol, butanol, or n-propanol; a ketone, such as acetone, methylethyl ketone, or methyl isobutyl ketone; an aromatic hydrocarbon, such as benzene, toluene, or xylene; an aliphatic hydrocarbon, such as heptane, hexane, or octane; a glycol ether, such as propylene glycol methyl ether, dipropylene glycol methyl ether, propylene glycol n-butyl ether, propylene glycol n-propyl ether, or ethylene glycol n-butyl ether; or a halogenated hydrocarbon, such as dichloromethane, 1,1,1-trichloroethane or methylene chloride, chloroform, dimethyl sulfoxide, dimethyl formamide, acetonitrile, tetrahydrofuran, white spirits, mineral spirits, or naphtha.

The amount of solvent can be up to 70 weight percent, but is typically from about 20 to about 50 weight percent, based on the total weight of components in the hydrosilylation reaction. The solvent used during the hydrosilylation reaction can be subsequently removed from the resulting organosilane by various known methods.

### Composition:

The organosilane formed according to the process of this disclosure is generally of the formula:

(R¹)₍₃₋ₙ₎(R²O)ₙSiR³O(CH₂CH₂O)ₐ(C₃H₆O)_{b}R⁴

In this formula, each of “n”, “a”, “b”, R¹, R² and R⁴ is as defined above. R³ is a divalent hydrocarbon group containing 2 to 12 carbon atoms. Specifically, the divalent hydrocarbon group can contain 2, 3, 4, 5, 6, 7, 8, 9, 10, 11, or 12 carbon atoms or any range of values therebetween.

R³ is imparted by the hydrosilylation reaction between component a) and component b). Specifically, R³ is generally imparted by the hydrosilylation reaction between the SiH group of component a) and the R⁵ group of component b). As such, R³ can be of any chemistry resulting from the hydrosilylation reaction of such reactive groups described herein.

In various embodiments, R³ is ethylene, propylene, butylene, isobutylene, pentamethylene, hexamethylene, —CH₂CH₂C(CH₃)₂—, —CH₂CHCH₃—, —CH₂CH(CH₃)CH₂—, 3-ethyl-hexamethylene, octamethylene, or decamethylene. In certain embodiments, R³ is —CH₂CH₂C(CH₃)₂—, —CH═CHC(CH₃)₂—, or —CH═CHC(CH₃)₂CH₂—.

In further embodiments, R³ is —CH₂CH₂CH₂—, —CH₂CH₂CH(CH₃)—, or —CH₂CH₂C(CH₃)₂—. In a specific embodiment, R³ is —CH₂CH₂C(CH₃)₂—. In another specific embodiment, R³ is —CH₂CH(CH₃)CH₂—.

In one embodiment, the organosilane has the following average formula:

(CH₃)(CH₃CH₂O)₂SiCH₂CH₂CH₂O(CH₂CH₂O)₇CH₃.

In another embodiment, the organosilane has the following average formula:

(CH₃)(CH₃O)₂SiCH₂CH₂C(CH₃)₂O(CH₂CH₂O)₁₈(C₃H₆O)₁₈H.

In yet another embodiment, the organosilane has the following average formula:

(CH₃)(CH₃CH₂O)₂SiCH₂CH(CH₃)CH₂O(CH₂CH₂O)₇CH₃.

The present organosilanes may be prepared by any method known in the art for preparing organosilanes, or alternatively the organosilanes may be prepared by the process of this disclosure.

The present organosilanes contain at least one alkoxy group, as represented by (R²O) in the formulae above. As such, the present organosilanes will generally hydrolyze in aqueous medium, and may further condense to form oligomeric or higher molecular weight polymeric siloxanes. Thus, the present disclosure also relates to the reaction products resulting from the hydrolysis and/or condensation of the aforementioned organosilanes. The present organosilanes, or subsequently produced oligomeric or polymeric siloxanes derived from the organosilanes, may react with hydroxyl functional compounds or surfaces.

In embodiments where the polyalkylene oxide chain is predominately ethylene oxide, the present organosilanes may be considered as “hydrophilic”. Thus, the present organosilanes may be used to treat various surfaces to impart greater “hydrophilicity” to the surface. Furthermore, the reactivity of the silane moiety may allow the present compositions to bond to various surfaces to provide a longer lasting, more durable hydrophilic treatment.

In embodiments where the polyalkylene oxide chain is predominately propylene oxide, the present organosilanes may be considered as “hydrophobic”. Thus, the present organosilanes may be used to treat various surfaces to impart greater “hydrophobicity” to the surface. Furthermore, the reactivity of the silane moiety may allow the present compositions to bond to various surfaces to provide a longer lasting, more durable hydrophobic treatment.

When used to treat various surfaces, the organosilane may be applied neat, as an aqueous solution, as a solution in an organic solvent, or as a component in a multi-component formulation. When applied as a solution, additional components such as acids or bases to buffer the pH may be added to the solution, which are known to enhance the hydrolysis and condensation of alkoxysilanes.

The present organosilanes, or reaction products derived therefrom, may be used to improve the hydrophilicity or hydrophobicity of various surfaces. Said another way, they may be used as surface modifiers. The treatments may be longer lasting or more durable than conventional treatments. Surfaces suitable for treatment include various hard surfaces such as glass, metals, plastics, minerals, and woods. The surfaces further include fibers, fabrics or textile surfaces. Fibers or textiles that can be treated with the treatment composition include natural fibers such as cotton, silk, linen, and wool; regenerated fibers such as rayon and acetate; synthetic fibers such as polyesters, polyamides, polyacrylonitriles, polyethylenes, and polypropylenes; combinations, and blends thereof. The form of the fibers can include threads, filaments, tows, yarns, woven fabrics, knitted materials, non-woven materials, paper, carpet, and leather. In a further embodiment, the fiber is a cellulosic fiber such as cotton.

The fiber treatment composition comprising the present organosilanes, oligomeric or polymers derived therefrom, can be applied to the fiber and/or textile during making the fibers or textiles, or later via a post application process. After application, carriers (if any) can be removed from the treatment composition for example by drying the composition at ambient or elevated temperature. The amount of treatment composition applied to the fibers and textiles is typically sufficient to provide about 0.1 to about 15 weight percent of the composition on the fibers and textiles, based on their dry weight, more typically in an amount of about 0.2 to about 5 weight percent based on the dry weight of the fiber or textile.

The present organosilanes, or reaction products derived therefrom, may be used as intermediates. For example, they can be used in the production of plastics and polymers, such as polyurethane foams.

### Personal Care Composition:

This disclosure also provides a personal care composition, which may also be referred to herein as a “personal care product”. The personal care composition includes the organosilane and/or organosilane composition described above. The personal care composition may be in the form of a cream, a gel, a powder, a paste, or a freely pourable liquid. Generally, such personal care compositions can generally be prepared at room temperature if no solid materials at room temperature are present in the personal care compositions, using simple propeller mixers, Brookfield counter-rotating mixers, or homogenizing mixers. No special equipment or processing conditions are typically required. Depending on the type of form made, the method of preparation will be different, but such methods are well known in the art.

The personal care composition can be used in or for a variety of personal, household, and healthcare applications. In particular, the organosilane composition and/or personal care composition of the present disclosure may be used in the personal care products as described in U.S. Pat. Nos. 6,051,216, 5,919,441, 5,981,680; WO2004/060271 and WO2004/060101; in sunscreen compositions as described in WO2004/060276; in cosmetic compositions also containing film-forming resins, as described in WO03/105801; in the cosmetic compositions as described in US Pub. Nos. 2003/0235553, 2003/0072730 and 2003/0170188, in EP Pat. Nos. 1,266,647, 1,266,648, and 1,266,653, in WO03/105789, WO2004/000247 and WO03/106614; as additional agents to those described in WO2004/054523; in long wearing cosmetic compositions as described in US Pub. No. 2004/0180032; and/or in transparent or translucent care and/or make up compositions as described in WO2004/054524; all of which are expressly incorporated herein by reference in various non-limiting embodiments.

The personal care products may be functional with respect to the portion of the body to which they are applied, cosmetic, therapeutic, or some combination thereof. Conventional examples of such personal care products include, but are not limited to: antiperspirants and deodorants; skin care creams, skin care lotions, moisturizers, and facial treatments, such as acne or wrinkle removers; personal and facial cleansers; bath oils; perfumes and colognes; sachets; sunscreens; pre-shave and after-shave lotions; shaving soaps, and shaving lathers; hair shampoos, hair conditioners, hair colorants, hair relaxants, hair sprays, mousses, gels, permanents, depilatories, and cuticle coats; make-ups, color cosmetics, foundations, concealers, blushes, lipsticks, eyeliners, mascara, oil removers, color cosmetic removers, and powders; and medicament creams, pastes or sprays including antiacne, dental hygienic, antibiotic, healing promotive, nutritive and the like, which may be preventative and/or therapeutic. In general the personal care products may be formulated with a carrier that permits application in any conventional form, including but not limited to liquids, rinses, lotions, creams, pastes, gels, foams, mousses, ointments, sprays, aerosols, soaps, sticks, soft solids, solid gels, and gels. What constitutes a suitable carrier is readily apparent to one of ordinary skill in the art.

Personal care compositions for personal care may alternatively be referred to as cosmetic compositions and include those that are intended to be placed in contact with external portions of the human body (skin, hair, nails, mucosa, etc., also referred to as “keratinous substrates”) or with the teeth and the mucous membranes of the oral cavity with a view exclusively or mainly to cleaning them, perfuming them, changing their appearance, protecting them, keeping them in good condition or modifying odors. In some instances, personal care compositions also include health care compositions. Cosmetic applications, and in some instances health care applications, include skin care, sun care, hair care, or nail care applications.

Personal care ingredients are those components used in personal care or cosmetic applications. A wide review of such components may be found in the CTFA cosmetic component handbook. Exemplary personal care ingredients are described in further detail below. These personal care ingredients may alternative be referred to as cosmetic components, health care components, etc. depending on the typical use thereof. When the personal care ingredient is the cosmetic component, the personal care composition is referred to as a cosmetic composition; when the personal care ingredient is the health care component, the personal care composition is referred to as a health care composition, etc.

Cosmetic components include emollients, waxes, moisturizers, surface active materials (such as surfactants or detergents or emulsifiers), thickeners, water phase stabilizing agents, pH controlling agents, preservatives and cosmetic biocides, sebum absorbants or sebum control agents, vegetable or botanical extracts, vitamins, proteins or amino-acids and their derivatives, pigments, colorants, fillers, silicone conditioning agents, cationic conditioning agents, hydrophobic conditioning agents, UV absorbers, sunscreen agents, antidandruff agents, antiperspirant agents, deodorant agents, skin protectants, hair dyes, nail care components, fragrances or perfume, antioxidants, oxidizing agents, reducing agents, propellant gases, and mixtures thereof. Additional components that may be used in the cosmetic compositions include fatty alcohols, color care additives, anticellulites, pearlising agents, chelating agents, film formers, styling agents, ceramides, suspending agents and others.

Health care components include antiacne agents, antibacterial agents, antifungal agents, therapeutic active agents, external analgesics, skin bleaching agents, anti-cancer agents, diuretics, agents for treating gastric and duodenal ulcers, proteolytic enzymes, antihistamine or H1 histamine blockers, sedatives, bronchodilators, diluents, and others. Additional components that may be used in the health care compositions include antibiotics, antiseptics, antibacterial agents, anti-inflammatory agents, astringents, hormones, smoking cessation compositions, cardiovascular agents, antiarrhythmic agents, alpha-I blockers, beta blockers, ACE inhibitors, antiaggregants, non-steroidal anti-inflammatory agents (NSAIDs; such as diclofenac), antipsoriasis agents (such as clobetasol propionate), antidermatitis agents, tranquilizer, anticonvulsants, anticoagulant agents, healing factors, cell growth nutrients, peptides, corticosteroidal drugs, antipruritic agents and others.

Cosmetic components may be used in health care compositions, such as waxes, and others; and health care components may be used in cosmetic compositions, such as anti-acne agents, and others.

Examples of emollients include volatile or non-volatile silicone oils; silicone resins, such as polypropylsilsesquioxane and phenyl trimethicone; silicone elastomers, such as dimethicone cross-polymers; alkylmethylsiloxanes, such as C30-45 alkyl methicone; volatile or non-volatile hydrocarbon compounds, such as squalene, paraffin oils, petrolatum oils and naphthalene oils; hydrogenated or partially hydrogenated polyisobutene; isoeicosane; squalane; isoparaffin; isododecane; isodecane or isohexa-decane; branched C8-C16 esters; isohexyl neopentanoate; ester oils, such as isononyl isononanoate, cetostearyl octanoate, isopropyl myristate, palmitate derivatives, stearates derivatives, isostearyl isostearate and the heptanoates, octanoates, decanoates or ricinoleates of alcohols or of polyalcohols, or mixtures thereof; hydrocarbon oils of plant origin, such as wheatgerm, sunflower, grapeseed, castor, shea, avocado, olive, soybean, sweet almond, palm, rapeseed, cotton seed, hazelnut, macadamia, jojoba, blackcurrant, evening primrose; triglycerides of caprylic/capric acids; higher fatty acids, such as oleic acid, linoleic acid or linolenic acid; and mixtures thereof.

Examples of waxes include hydrocarbon waxes, such as beeswax, lanolin wax, rice wax, carnauba wax, candelilla wax, microcrystalline waxes, paraffins, ozokerite, polyethylene waxes, synthetic wax, ceresin, lanolin, lanolin derivatives, cocoa butter, shellac wax, bran wax, capok wax, sugar cane wax, montan wax, whale wax, bayberry wax, silicone waxes (e.g. polymethylsiloxane alkyls, alkoxys and/or esters, C30-C45 alkyldimethylsilyl polypropylsilsesquioxane), and mixtures thereof.

Examples of moisturizers include lower molecular weight aliphatic diols, such as propylene glycol and butylene glycol; polyols, such as glycerine and sorbitol; and polyoxyethylene polymers, such as polyethylene glycol 200; hyaluronic acid and its derivative; and mixtures thereof.

Examples of surface active materials may be anionic, cationic or nonionic, and include organomodified silicones, such as dimethicone copolyol; oxyethylenated and/or oxypropylenated ethers of glycerol; oxyethylenated and/or oxypropylenated ethers of fatty alcohols, such as ceteareth-30, C12-C15 pareth-7; fatty acid esters of polyethylene glycol, such as PEG-50 stearate and PEG-40 monostearate; saccharide esters and ethers, such as sucrose stearate, sucrose cocoate and sorbitan stearate, and mixtures thereof; phosphoric esters and salts thereof, such as DEA oleth-10 phosphate; sulphosuccinates, such as disodium PEG-5 citrate lauryl sulphosuccinate and disodium ricinoleamido MEA sulphosuccinate; alkyl ether sulphates, such as sodium lauryl ether sulphate; isethionates; betaine derivatives; and mixtures thereof.

Further examples of nonionic surfactants include polyoxyethylene alkyl ethers, polyoxyethylene alkylphenol ethers, polyoxyethylene lauryl ethers, polyoxyethylene sorbitan monoleates, polyoxyethylene alkyl esters, polyoxyethylene sorbitan alkyl esters, polyethylene glycol, polypropylene glycol, diethylene glycol, ethoxylated trimethylnonanols, polyoxyalkylene-substituted silicones (rake or [AB]ₙ types), silicone alkanolamides, silicone esters, silicone glycosides, and mixtures thereof.

Nonionic surfactants include dimethicone copolyols, fatty acid esters of polyols, for instance sorbitol or glyceryl mono-, di-, tri- or sesqui-oleates or stearates, glyceryl or polyethylene glycol laurates; fatty acid esters of polyethylene glycol (polyethylene glycol monostearate or monolaurate); polyoxyethylenated fatty acid esters (stearate or oleate) of sorbitol; polyoxyethylenated alkyl (lauryl, cetyl, stearyl or octyl)ethers.

Anionic surfactants include carboxylates (sodium 2-(2-hydroxyalkyloxy)acetate)), amino acid derivatives (N-acylglutamates, N-acylgly-cinates or acylsarcosinates), alkyl sulfates, alkyl ether sulfates and oxyethylenated derivatives thereof, sulfonates, isethionates and N-acylisethionates, taurates and N-acyl N-methyltaurates, sulfosuccinates, alkylsulfoacetates, phosphates and alkyl phosphates, polypeptides, anionic derivatives of alkyl polyglycoside (acyl-D-galactoside uronate), and fatty acid soaps, and mixtures thereof.

Amphoteric and zwitterionic surfactants include betaines, N-alkylamidobetaines and derivatives thereof, proteins and derivatives thereof, glycine derivatives, sultaines, alkyl polyaminocarboxylates and alkylamphoacetates, and mixtures thereof.

Examples of thickeners include acrylamide copolymers, acrylate copolymers and salts thereof (such as sodium polyacrylate), xanthan gum and derivatives, cellulose gum and cellulose derivatives (such as methylcellulose, methylhydroxypropylcellulose, hydroxypropylcellulose, polypropylhydroxyethylcellulose), starch and starch derivatives (such as hydroxyethylamylose and starch amylase), polyoxyethylene, carbomer, sodium alginate, arabic gum, cassia gum, guar gum and guar gum derivatives, cocamide derivatives, alkyl alcohols, gelatin, PEG- derivatives, saccharides (such as fructose, glucose) and saccharides derivatives (such as PEG-120 methyl glucose diolate), and mixtures thereof.

Examples of water phase stabilizing agents include electrolytes (e.g. alkali metal salts and alkaline earth salts, especially the chloride, borate, citrate, and sulfate salts of sodium, potassium, calcium and magnesium, as well as aluminum chlorohydrate, and polyelectrolytes, especially hyaluronic acid and sodium hyaluronate), polyols (glycerine, propylene glycol, butylene glycol, and sorbitol), alcohols (such as ethyl alcohol), hydrocolloids, and mixtures thereof.

Examples of pH controlling agents include any water soluble acid, such as a carboxylic acid or a mineral acid, such as hydrochloric acid, sulphuric acid, and phosphoric acid, monocarboxylic acid, such as acetic acid and lactic acid, and polycarboxylic acids, such as succinic acid, adipic acid, citric acid, and mixtures thereof.

Example of preservatives and cosmetic biocides include paraben derivatives, hydantoin derivatives, chlorhexidine and its derivatives, imidazolidinyl urea, phenoxyethanol, silver derivatives, salicylate derivatives, triclosan, ciclopirox olamine, hexamidine, oxyquinoline and its derivatives, PVP-iodine, zinc salts and derivatives, such as zinc pyrithione, and mixtures thereof.

Examples of sebum absorbants or sebum control agents include silica silylate, silica dimethyl silylate, dimethicone/vinyl dimethicone cross-polymer, polymethyl methacrylate, cross-linked methylmethacrylate, aluminum starch octenylsuccinate, and mixtures thereof.

Examples of vegetable or botanical extracts are derived from plants (herbs, roots, flowers, fruits, or seeds) in oil or water soluble form, such as coconut, green tea, white tea, black tea, horsetail, ginkgo biloba, sunflower, wheat germ, seaweed, olive, grape, pomegranate, aloe, apricot kernel, apricot, carrot, tomato, tobacco, bean, potato, actzuki bean, catechu, orange, cucumber, avocado, watermelon, banana, lemon, palm, or mixtures thereof. Examples of herbal extracts include dill, horseradish, oats, neem, beet, broccoli, tea, pumpkin, soybean, barley, walnut, flax, ginseng, poppy, avocado, pea, sesame, and mixtures thereof.

Examples of vitamins include a variety of different organic compounds, such as alcohols, acids, sterols, and quinones. They may be classified into two solubility groups: lipid-soluble vitamins and water-soluble vitamins. Lipid-soluble vitamins that have utility in personal care compositions include retinol (vitamin A), ergocalciferol (vitamin D2), cholecalciferol (vitamin D3), phytonadione (vitamin K1), and tocopherol (vitamin E). Water-soluble vitamins that have utility in personal care compositions include ascorbic acid (vitamin C), thiamin (vitamin B1), niacin (nicotinic acid), niacinamide (vitamin B3), riboflavin (vitamin B2), pantothenic acid (vitamin B5), biotin, folic acid, pyridoxine (vitamin B6), and cyanocobalamin (vitamin B12). Additional examples of vitamins include derivatives of vitamins, such as retinyl palmitate (vitamin A palmitate), retinyl acetate (vitamin A acetate), retinyl linoleate (vitamin A linoleate), retinyl propionate (vitamin A propionate), tocopheryl acetate (vitamin E acetate), tocopheryl linoleate (vitamin E linoleate), tocopheryl succinate (vitamin E succinate), tocophereth-5, tocophereth-10, tocophereth-12, tocophereth-18, tocophereth-50 (ethoxylated vitamin E derivatives), PPG-2 tocophereth-5, PPG-5 tocophereth-2, PPG-10 tocophereth-30, PPG-20 tocophereth-50, PPG-30 tocophereth-70, PPG-70 tocophereth-100 (propoxylated and ethoxylated vitamin E derivatives), sodium tocopheryl phosphate, ascorbyl palmitate, ascorbyl dipalmitate, ascorbyl glucoside, ascorbyl tetraisopalmitate, tetrahexadecyl ascorbate, ascorbyl tocopheryl maleate, potassium ascorbyl tocopheryl phosphate, tocopheryl nicotinate, and mixtures thereof.

Examples of proteins or amino-acids and their derivatives include those extracted from wheat, soy, rice, corn, keratin, elastin or silk. Proteins may be in the hydrolyzed form and they may also be quaternized, such as hydrolyzed elastin, hydrolyzed wheat powder, hydrolyzed silk. Examples of protein include enzymes, such as hydrolases, cutinases, oxidases, transferases, reductases, hemicellulases, esterases, isomerases, pectinases, lactases, peroxidases, laccases, catalases, and mixtures thereof. Examples of hydrolases include proteases (bacterial, fungal, acid, neutral or alkaline), amylases (alpha or beta), lipases, mannanases, cellulases, collagenases, lisozymes, superoxide dismutase, catalase, and mixtures thereof.

Examples of pigments and colorants include surface treated or untreated iron oxides, surface treated or untreated titanium dioxide, surface treated or untreated mica, silver oxide, silicates, chromium oxides, carotenoids, carbon black, ultramarines, chlorophyllin derivatives and yellow ocher. Examples of organic pigments include aromatic types including azo, indigoid, triphenylmethane, anthraquinone, and xanthine dyes which are designated as D&C and FD&C blues, browns, greens, oranges, reds, yellows, etc., and mixtures thereof. Surface treatments include those treatments based on lecithin, silicone, silanes, fluoro compounds, and mixtures thereof.

Examples of fillers include talc, micas, kaolin, zinc or titanium oxides, calcium or magnesium carbonates, silica, silica silylate, titanium dioxide, glass or ceramic beads, polymethylmethacrylate beads, boron nitride, aluminum silicate, aluminum starch octenylsuccinate, bentonite, magnesium aluminum silicate, nylon, silk powder metal soaps derived from carboxylic acids having 8-22 carbon atoms, non-expanded synthetic polymer powders, expanded powders and powders from natural organic compounds, such as cereal starches, which may or may not be cross-linked, copolymer microspheres, polytrap, silicone resin microbeads, and mixtures thereof. The fillers may be surface treated to modify affinity or compatibility with remaining components.

Examples of silicone conditioning agents include silicone oils, such as dimethicone; silicone gums, such as dimethiconol; silicone resins, such as trimethylsiloxy silicate, and polypropyl silsesquioxane; silicone elastomers; alkylmethylsiloxanes; organomodified silicone oils, such as amodimethicone, aminopropyl phenyl trimethicone, phenyl trimethicone, trimethyl pentaphenyl trisiloxane, silicone quaternium-16/glycidoxy dimethicone cross-polymer, and silicone quaternium-16; saccharide functional siloxanes; carbinol functional siloxanes; silicone polyethers; siloxane copolymers (divinyldimethicone/dimethicone copolymer); acrylate or acrylic functional siloxanes; and mixtures or emulsions thereof.

Examples of cationic conditioning agents include guar derivatives, such as hydroxypropyltrimethylammonium derivative of guar gum; cationic cellulose derivatives, cationic starch derivatives; quaternary nitrogen derivatives of cellulose ethers; homopolymers of dimethyldiallyl ammonium chloride; copolymers of acrylamide and dimethyldiallyl ammonium chloride; homopolymers or copolymers derived from acrylic acid or methacrylic acid which contain cationic nitrogen functional groups attached to the polymer by ester or amide linkages; polymeric quaternary ammonium salts of hydroxyethyl cellulose reacted with a fatty alkyl dimethyl ammonium substituted epoxide; polycondensation products of N,N′-bis-(2,3-epoxypropyl)-piperazine or piperazine-bis-acrylamide and piperazine; and copolymers of vinylpyrrolidone and acrylic acid esters with quaternary nitrogen functionality. Specific materials include the various polyquats Polyquaternium-7, Polyquaternium-8, Polyquaternium-10, Polyquaternium-11, and Polyquaternium-23. Other categories of conditioners include cationic surfactants, such as cetyl trimethylammonium chloride, cetyl trimethylammonium bromide, stearyltrimethylammonium chloride, and mixtures thereof. In some instances, the cationic conditioning agent is also hydrophobically modified, such as hydrophobically modified quaternized hydroxyethylcellulose polymers; cationic hydrophobically modified galactomannan ether; and mixtures thereof.

Examples of hydrophobic conditioning agents include guar derivatives; galactomannan gum derivatives; cellulose derivatives; and mixtures thereof.

UV absorbers and sunscreen agents include those which absorb ultraviolet light between about 290-320 nanometers (the UV-B region) and those which absorb ultraviolet light in the range of 320-400 nanometers (the UV-A region).

Some examples of sunscreen agents are aminobenzoic acid, cinoxate, diethanolamine methoxycinnamate, digalloyl trioleate, dioxybenzone, ethyl 4-[bis(Hydroxypropyl)] aminobenzoate, glyceryl aminobenzoate, homosalate, lawsone with dihydroxyacetone, menthyl anthranilate, octocrylene, ethyl hexyl methoxycinnamate, octyl salicylate, oxybenzone, padimate O, phenylbenzimidazole sulfonic acid, red petrolatum, sulisobenzone, titanium dioxide, trolamine salicylate, and mixtures thereof.

Some examples of UV absorbers are acetaminosalol, allatoin PABA, benzalphthalide, benzophenone, benzophenone 1-12, 3-benzylidene camphor, benzylidenecamphor hydrolyzed collagen sulfonamide, benzylidene camphor sulfonic Acid, benzyl salicylate, bornelone, bumetriozole, butyl methoxydibenzoylmethane, butyl PABA, ceria/silica, ceria/silica talc, cinoxate, DEA-methoxycinnamate, dibenzoxazol naphthalene, di-t-butyl hydroxybenzylidene camphor, digalloyl trioleate, diisopropyl methyl cinnamate, dimethyl PABA ethyl cetearyldimonium tosylate, dioctyl butamido triazone, diphenyl carbomethoxy acetoxy naphthopyran, disodium bisethylphenyl tiamminotriazine stilbenedisulfonate, disodium distyrylbiphenyl triaminotriazine stilbenedisulfonate, disodium distyrylbiphenyl disulfonate, drometrizole, drometrizole trisiloxane, ethyl dihydroxypropyl PABA, ethyl diisopropylcinnamate, ethyl methoxycinnamate, ethyl PABA, ethyl urocanate, etrocrylene ferulic acid, glyceryl octanoate dimethoxycinnamate, glyceryl PABA, glycol salicylate, homosalate, isoamyl p-methoxycinnamate, isopropylbenzyl salicylate, isopropyl dibenzolylmethane, isopropyl methoxycinnamate, menthyl anthranilate, menthyl salicylate, 4-methylbenzylidene, camphor, octocrylene, octrizole, octyl dimethyl PABA, ethyl hexyl methoxycinnamate, octyl salicylate, octyl triazone, PABA, PEG-25 PABA, pentyl dimethyl PABA, phenylbenzimidazole sulfonic acid, polyacrylamidomethyl benzylidene camphor, potassium methoxycinnamate, potassium phenylbenzimidazole sulfonate, red petrolatum, sodium phenylbenzimidazole sulfonate, sodium urocanate, TEA-phenylbenzimidazole sulfonate, TEA-salicylate, terephthalylidene dicamphor sulfonic acid, titanium dioxide, triPABA panthenol, urocanic acid, VA/crotonates/methacryloxybenzophenone-1 copolymer, and mixtures thereof.

Examples of antidandruff agents include pyridinethione salts, selenium compounds, such as selenium disulfide, and soluble antidandruff agents, and mixtures thereof.

Examples of antiperspirant agents and deodorant agents include aluminum chloride, aluminum zirconium tetrachlorohydrex GLY, aluminum zirconium tetrachlorohydrex PEG, aluminum chlorohydrex, aluminum zirconium tetrachlorohydrex PG, aluminum chlorohydrex PEG, aluminum zirconium trichlorohydrate, aluminum chlorohydrex PG, aluminum zirconium trichlorohydrex GLY, hexachlorophene, benzalkonium chloride, aluminum sesquichlorohydrate, sodium bicarbonate, aluminum sesquichlorohydrex PEG, chlorophyllin-copper complex, triclosan, aluminum zirconium octachlorohydrate, zinc ricinoleate, and mixtures thereof.

Examples of skin protectants include allantoin, aluminum acetate, aluminum hydroxide, aluminum sulfate, calamine, cocoa butter, cod liver oil, colloidal oatmeal, dimethicone, glycerin, kaolin, lanolin, mineral oil, petrolatum, shark liver oil, sodium bicarbonate, talc, witch hazel, zinc acetate, zinc carbonate, zinc oxide, and mixtures thereof.

Examples of hair dyes include 1-acetoxy-2-methylnaphthalene; acid dyes; 5-amino-4-chloro-o-cresol; 5-amino-2,6-dimethoxy-3-hydroxypyridine; 3-amino-2,6-dimethylphenol; 2-amino-5-ethylphenol HCl; 5-amino-4-fluoro-2-methylphenol sulfate; 2-amino-4-hydroxyethylaminoanisole; 2-amino-4-hydroxyethylaminoanisole sulfate; 2-amino-5-nitrophenol; 4-amino-2-nitrophenol; 4-amino-3-nitrophenol; 2-amino-4-nitrophenol sulfate; m-aminophenol HCl; p-aminophenol HCl; m-aminophenol; o-aminophenol; 4,6-bis(2-hydroxyethoxy)-m-phenylenediamine HCl; 2,6-bis(2-hydroxyethoxy)-3,5-pyridinediamine HCl; 2-chloro-6-ethylamino-4-nitrophenol; 2-chloro-5-nitro-N-hydroxyethyl p-phenylenediamine; 2-chloro-p-phenylenediamine; 3,4-diaminobenzoic acid; 4,5-diamino-1-((4-chlorophenyl)methyl)-1H-pyrazole-sulfate; 2,3-diaminodihydropyrazolo pyrazolone dimethosulfonate; 2,6-diaminopyridine; 2,6-diamino-3-((pyridin-3-yl)azo)pyridine; dihydroxyindole; dihydroxyindoline; N,N-dimethyl-p-phenylenediamine; 2,6-dimethyl-p-phenylenediamine; N,N-dimethyl-p-phenylenediamine sulfate; direct dyes; 4-ethoxy-m-phenylenediamine sulfate; 3-ethylamino-p-cresol sulfate; N-ethyl-3-nitro PABA; gluconamidopropyl aminopropyl dimethicone; Haematoxylon brasiletto wood extract; HC dyes; Lawsonia inermis (Henna) extract; hydroxyethyl-3,4-methylenedioxyaniline HCl; hydroxyethyl-2-nitro-p-toluidine; hydroxyethyl-p-phenylenediamine sulfate; 2-hydroxyethyl picramic acid; hydroxypyridinone; hydroxysuccinimidyl C21-C22 isoalkyl acidate; isatin; Isatis tinctoria leaf powder; 2-methoxymethyl-p-phenylenediamine sulfate; 2-methoxy-p-phenylenediamine sulfate; 6-methoxy-2,3-pyridinediamine HCl; 4-methylbenzyl 4,5-diamino pyrazole sulfate; 2,2′-methylenebis 4-aminophenol; 2,2′-methylenebis-4-aminophenol HCl; 3,4-methylenedioxyaniline; 2-methylresorcinol; methylrosanilinium chloride; 1,5-naphthalenediol; 1,7-naphthalenediol; 3-nitro-p-Cresol; 2-nitro-5-glyceryl methylaniline; 4-nitroguaiacol; 3-nitro-p-hydroxyethylaminophenol; 2-nitro-N-hydroxyethyl-p-anisidine; nitrophenol; 4-nitrophenyl aminoethylurea; 4-nitro-o-phenylenediamine dihydrochloride; 2-nitro-p-phenylenediamine dihydrochloride; 4-nitro-o-phenylenediamine HCl; 4-nitro-m-phenylenediamine; 4-nitro-o-phenylenediamine; 2-nitro-p-phenylenediamine; 4-nitro-m-phenylenediamine sulfate; 4-nitro-o-phenylenediamine sulfate; 2-nitro-p-phenylenediamine sulfate; 6-nitro-2,5-pyridinediamine; 6-nitro-o-toluidine; PEG-3 2,2′-di-p-phenylenediamine; p-phenylenediamine HCl; p-phenylenediamine sulfate; phenyl methyl pyrazolone; N-phenyl-p-phenylenediamine HCl; pigment blue 15:1; pigment violet 23; pigment yellow 13; pyrocatechol; pyrogallol; resorcinol; sodium picramate; sodium sulfanilate; solvent yellow 85; solvent yellow 172; tetraaminopyrimidine sulfate; tetrabromophenol blue; 2,5,6-triamino-4-pyrimidinol sulfate; and 1,2,4-trihydroxybenzene.

Examples of nail care components include butyl acetate; ethyl acetate; nitrocellulose; acetyl tributyl citrate; isopropyl alcohol; adipic acid/neopentyl glycol/trimelitic anhydride copolymer; stearalkonium bentonite; acrylates copolymer; calcium pantothenate; Cetraria islandica extract; Chondrus crispus; styrene/acrylates copolymer; trimethylpentanediyl dibenzoate-1; polyvinyl butyral; N-butyl alcohol; propylene glycol; butylene glycol; mica; silica; tin oxide; calcium borosilicate; synthetic fluorphlogopite; polyethylene terephtalate; sorbitan laurate derivatives; talc; jojoba extract; diamond powder; isobutylphenoxy epoxy resin; silk powder; and mixtures thereof.

Examples of fragrances or perfume include hexyl cinnamic aldehyde; anisaldehyde; methyl-2-n-hexyl-3-oxo-cyclopentane carboxylate; dodecalactone gamma; methylphenylcarbinyl acetate; 4-acetyl-6-tert-butyl-1,1-dimethyl indane; patchouli; olibanum resinoid; labdanum; vetivert; copaiba balsam; fir balsam; 4-(4-hydroxy-4-methyl pentyl)-3-cyclohexene-1-carboxaldehyde; methyl anthranilate; geraniol; geranyl acetate; linalool; citronellol; terpinyl acetate; benzyl salicylate; 2-methyl-3-(p-isopropylphenyl)-propanal; phenoxyethyl isobutyrate; cedryl acetal; aubepine; musk fragrances; macrocyclic ketones; macrolactone musk fragrances; ethylene brassylate; and mixtures thereof. Further perfume components are described in detail in standard textbook references, such as Perfume and Flavour Chemicals, 1969, S. Arctander, Montclair, New Jersey.

Examples of antioxidants are acetyl cysteine, arbutin, ascorbic acid, ascorbic acid polypeptide, ascorbyl dipalmitate, ascorbyl methylsilanol pectinate, ascorbyl palmitate, ascorbyl stearate, BHA, p-hydroxyanisole, BHT, t-butyl hydroquinone, caffeic acid, Camellia sinensis oil, chitosan ascorbate, chitosan glycolate, chitosan salicylate, chlorogenic acids, cysteine, cysteine HCl, decyl mercaptomethylimidazole, erythorbic acid, diamylhydroquinone, di-t-butylhydroquinone, dicetyl thiodipropionate, dicyclopentadiene/t-butylcresol copolymer, digalloyl trioleate, dilauryl thiodipropionate, dimyristyl thiodipropionate, dioleyl tocopheryl methylsilanol, isoquercitrin, diosmine, disodium ascorbyl sulfate, disodium rutinyl disulfate, distearyl thiodipropionate, ditridecyl thiodipropionate, dodecyl gallate, ethyl ferulate, ferulic acid, hydroquinone, hydroxylamine HCl, hydroxylamine sulfate, isooctyl thioglycolate, kojic acid, madecassicoside, magnesium ascorbate, magnesium ascorbyl phosphate, melatonin, methoxy-PEG-7 rutinyl succinate, methylene di-t-butylcresol, methylsilanol ascorbate, nordihydroguaiaretic acid, octyl gallate, phenylthioglycolic acid, phloroglucinol, potassium ascorbyl tocopheryl phosphate, thiodiglycolamide, potassium sulfite, propyl gallate, rosmarinic acid, rutin, sodium ascorbate, sodium ascorbyl/cholesteryl phosphate, sodium bisulfite, sodium erythorbate, sodium metabisulfide, sodium sulfite, sodium thioglycolate, sorbityl furfural, tea tree (Melaleuca aftemifolia) oil, tocopheryl acetate, tetrahexyldecyl ascorbate, tetrahydrodiferuloylmethane, tocopheryl linoleate/oleate, thiodiglycol, tocopheryl succinate, thiodiglycolic acid, thioglycolic acid, thiolactic acid, thiosalicylic acid, thiotaurine, retinol, tocophereth-5, tocophereth-10, tocophereth-12, tocophereth-18, tocophereth-50, tocopherol, tocophersolan, tocopheryl linoleate, tocopheryl nicotinate, tocoquinone, o-tolyl biguanide, tris(nonylphenyl) phosphite, ubiquinone, zinc dibutyldithiocarbamate, and mixtures thereof.

Examples of oxidizing agents are ammonium persulfate, calcium peroxide, hydrogen peroxide, magnesium peroxide, melamine peroxide, potassium bromate, potassium caroate, potassium chlorate, potassium persulfate, sodium bromate, sodium carbonate peroxide, sodium chlorate, sodium iodate, sodium perborate, sodium persulfate, strontium dioxide, strontium peroxide, urea peroxide, zinc peroxide, and mixtures thereof.

Examples of reducing agents are ammonium bisufite, ammonium sulfite, ammonium thioglycolate, ammonium thiolactate, cystemaine HCl, cystein, cysteine HCl, ethanolamine thioglycolate, glutathione, glyceryl thioglycolate, glyceryl thioproprionate, hydroquinone, p-hydroxyanisole, isooctyl thioglycolate, magnesium thioglycolate, mercaptopropionic acid, potassium metabisulfite, potassium sulfite, potassium thioglycolate, sodium bisulfite, sodium hydrosulfite, sodium hydroxymethane sulfonate, sodium metabisulfite, sodium sulfite, sodium thioglycolate, strontium thioglycolate, superoxide dismutase, thioglycerin, thioglycolic acid, thiolactic acid, thiosalicylic acid, zinc formaldehyde sulfoxylate, and mixtures thereof.

Examples of propellant gases include carbon dioxide, nitrogen, nitrous oxide, volatile hydrocarbons such as butane, isobutane, or propane, and chlorinated or fluorinated hydrocarbons such as dichlorodifluoromethane and dichlorotetrafluoroethane or dimethylether; and mixtures thereof.

Examples of antiacne agents include salicylic acid, sulfur benzoyl, peroxide, tretinoin, and mixtures thereof.

Examples of antibacterial agents include chlorohexadiene gluconate, alcohol, benzalkonium chloride, benzethonium chloride, hydrogen peroxide, methylbenzethonium chloride, phenol, poloxamer 188, povidone-iodine, and mixtures thereof.

Examples of antifungal agents include miconazole nitrate, calcium undecylenate, undecylenic acid, zinc undecylenate, and mixtures thereof.

Examples of therapeutic active agents include penicillins, cephalosporins, tetracyclines, macrolides, epinephrine, amphetamines, aspirin, acetominophen, barbiturates, catecholamines, benzodiazepine, thiopental, codeine, morphine, procaine, lidocaine, benzocaine, sulphonamides, ticonazole, perbuterol, furosamide, prazosin, hormones, prostaglandins, carbenicillin, salbutamol, haloperidol, suramin, indomethicane, diclofenac, glafenine, dipyridamole, theophylline, hydrocortisone, steroids, scopolamine, and mixtures thereof.

Examples of external analgesics are benzyl alcohol, capsicum oleoresin (Capsicum frutescens oleoresin), methyl salicylate, camphor, phenol, capsaicin, juniper tar (Juniperus oxycedrus tar), phenolate sodium (sodium phenoxide), capsicum (Capsicum frutescens), menthol, resorcinol, methyl nicotinate, turpentine oil (turpentine), and mixtures thereof. An example of a skin bleaching agent is hydroquinone.

Examples of diluents include silicon containing diluents, such as hexamethyldisiloxane, octamethyltrisiloxane, and other short chain linear siloxanes, such as octamethyltrisiloxane, decamethyltetrasiloxane, dodecamethylpentasiloxane, tetradecamethylhexasiloxane, hexadeamethylheptasiloxane, heptamethyl-3-{(trimethylsilyl)oxy)}trisiloxane, cyclic siloxanes, such as hexamethylcyclotrisiloxane, octamethylcyclotetrasiloxane, decamethylcyclopentasiloxane, dodecamethylcyclohexasiloxane; organic diluents, such as butyl acetate, alkanes, alcohols, ketones, esters, ethers, glycols, glycol ethers, and hydrofluorocarbons. Hydrocarbons include isododecane, isohexadecane, Isopar L (C11-C13), Isopar H (C11-C12), and hydrogentated polydecene. Ethers and esters include isodecyl neopentanoate, neopentylglycol heptanoate, glycol distearate, dicaprylyl carbonate, diethylhexyl carbonate, propylene glycol n-butyl ether, ethyl-3 ethoxypropionate, propylene glycol methyl ether acetate, tridecyl neopentanoate, propylene glycol methylether acetate (PGMEA), propylene glycol methylether (PGME), octyldodecyl neopentanoate, diisobutyl adipate, diisopropyl adipate, propylene glycol dicaprylate/dicaprate, and octyl palmitate. Additional organic diluents include fats, oils, fatty acids, and fatty alcohols.

The amount of the organosilane composition in the personal care compositions described above may vary from about 0.1-95, 0.2-50, or 0.5-25, wt % based on 100 parts by weight of the personal care composition. The personal care ingredient is present in an amount of from about 0.01-99.99 wt % based on 100 parts by weight of the personal care composition. Combinations of different personal care ingredients may be utilized. It is contemplated that any and all values or ranges of values between those described above may also be utilized.

The personal care compositions may be in the form of a cream, a gel, a powder (free flowing powder or pressed), a paste, a solid, freely pourable liquid, or an aerosol. The personal care compositions may be in the form of monophasic systems; biphasic or alternate multi phasic systems; emulsions, e.g. oil-in-water, water-in-oil, silicone-in-water, water-in-silicone; multiple emulsions, e.g. oil-in-water-in-oil, polyol-in-silicone-in-water, oil-in-water-in-silicone.

Skin care compositions include shower gels; soaps; hydrogels; creams; lotions and balms; antiperspirants and deodorants, such as sticks, soft solid, roll on, aerosol, and pumpsprays; skin creams; skin care lotions; moisturizers; facial treatments, such as wrinkle control or diminishment treatments; exfoliates; body and facial cleansers; bath oils; perfumes; colognes; sachets; sunscreens; mousses; patches; pre-shave and after-shave lotions; shaving soaps; shaving lathers; depilatories; make-ups; color cosmetics; foundations; concealers; blushes; lipsticks; eyeliners; mascaras; oil removers; color cosmetic removers, powders, and kits thereof.

Hair care compositions include shampoos, rinse-off conditioners, leave-in conditioners and styling aids, gels, sprays, pomades, mousses, waxes, hair colorants, hair relaxants, hair straighteners, permanents, and kits thereof.

Nail care compositions include color coats, base coats, cuticle coats, nail hardeners, and kits thereof.

Health care compositions may be in the form of ointments, creams, gels, mousses, pastes, patches, spray on bandages, foams and/or aerosols or the like, medicament creams, pastes or sprays including anti-acne, dental hygienic, antibiotic, healing promotive, which may be preventative and/or therapeutic medicaments, and kits thereof.

The personal care compositions may be used by standard methods, such as applying them to the human or animal body, e.g. skin or hair, using applicators, brushes, applying by hand, pouring them and/or optionally rubbing or massaging the composition onto or into the body.

The personal care compositions can be applied topically to the desired area of the skin or hair in an amount sufficient to provide a satisfactory cleansing or conditioning of the skin or hair. The personal care compositions may be diluted with water prior to, during, or after topical application, and then subsequently rinsed or wiped off of the applied surface, for example rinsed off of the applied surface using water or a water-insoluble substrate in combination with water.

The personal care compositions may be used on hair in a conventional manner. An effective amount of the composition for washing or conditioning hair is applied to the hair, with the effective amount typically ranging from about 1-50 grams. Application to the hair typically includes working the personal care composition through the hair such that most or all of the hair is contacted with the personal care composition. These steps can be repeated as many times as desired to achieve the desired benefit.

Benefits obtained from using the personal care compositions on hair include one or more of the following benefits: color retention, improvement in coloration process, hair conditioning, softness, detangling ease, silicone deposition, anti-static, anti-frizz, lubricity, shine, strengthening, viscosity, tactile, wet combing, dry combing, straightening, heat protection, styling, and curl retention.

The personal care compositions may be used on skin in a conventional manner. An effective amount of the personal care composition for the purpose is applied to the skin, with the effective amount typically ranging from about 1-3 mg/cm2. Application to the skin typically includes working the personal care composition into the skin as many times as desired to achieve the desired benefit.

Benefits obtained from using the personal care compositions on skin include one or more of the following benefits: stability in various formulations (o/w, w/o, anhydrous), utility as an emulsifier, level of hydrophobicity, organic compatibility, substantivity/durability, wash off resistance, interactions with sebum, performance with pigments, pH stability, skin softness, suppleness, moisturization, skin feel, long lasting, long wear, long lasting color uniformity, color enhancement, foam generation, optical effects (soft focus), and stabilization of actives.

The personal care composition may be used to care for keratinous substrates, to cleanse, to condition, to refresh, to make up, to remove make up, or to fix hair.

### Optional Additional Component(s):

The personal care composition and/or the organosilane composition may also include a solvent, such as (i) organic compounds, (ii) compounds containing a silicon atom, (iii) mixtures of organic compounds, (iv) mixtures of compounds containing a silicon atom, or (v) mixtures of organic compounds and compounds containing a silicon atom; used on an industrial scale to dissolve, suspend, or change the physical properties of other materials.

In general, the organic compounds are aromatic hydrocarbons, aliphatic hydrocarbons, alcohols, aldehydes, ketones, amines, esters, ethers, glycols, glycol ethers, alkyl halides, or aromatic halides. Representative of some common organic solvents are alcohols, such as methanol, ethanol, 1-propanol, cyclohexanol, benzyl alcohol, 2-octanol, ethylene glycol, propylene glycol, and glycerol; aliphatic hydrocarbons, such as pentane, cyclohexane, heptane, VM&P solvent, and mineral spirits; alkyl halides, such as chloroform, carbon tetrachloride, perchloroethylene, ethyl chloride, and chlorobenzene; amines, such as isopropylamine, cyclohexylamine, ethanolamine, and diethanolamine; aromatic hydrocarbons, such as benzene, toluene, ethylbenzene, and xylene; esters, such as ethyl acetate, isopropyl acetate, ethyl acetoacetate, amyl acetate, isobutyl isobutyrate, and benzyl acetate; ethers, such as ethyl ether, n-butyl ether, tetrahydrofuran, and 1,4-dioxane; glycol ethers, such as ethylene glycol monomethyl ether, ethylene glycol monomethyl ether acetate, diethylene glycol monobutyl ether, and propylene glycol monophenyl ether; ketones, such as acetone, methyl ethyl ketone, cyclohexanone, diacetone alcohol, methyl amyl ketone, and diisobutyl ketone; petroleum hydrocarbons, such as mineral oil, gasoline, naphtha, kerosene, gas oil, heavy oil, and crude oil; lubricating oils, such as spindle oil and turbine oil; and fatty oils, such as corn oil, soybean oil, olive oil, rape seed oil, cotton seed oil, sardine oil, herring oil, and whale oil.

“Other” miscellaneous organic solvents can also be used, such as acetonitrile, nitromethane, dimethylformamide, propylene oxide, trioctyl phosphate, butyrolactone, furfural, pine oil, turpentine, and m-creosol.

Solvents may also include volatile flavoring agents, such as oil of wintergreen; peppermint oil; spearmint oil; menthol; vanilla; cinnamon oil; clove oil; bay oil; anise oil; eucalyptus oil; thyme oil; cedar leaf oil; oil of nutmeg; oil of sage; cassia oil; cocoa; licorice; high fructose corn syrup; citrus oils, such as lemon, orange, lime, and grapefruit; fruit essences, such as apple, pear, peach, grape, strawberry, raspberry, cherry, plum, pineapple, and apricot; and other useful flavoring agents including aldehydes and esters, such as cinnamyl acetate, cinnamaldehyde, eugenyl formate, p-methylanisole, acetaldehyde, benzaldehyde, anisic aldehyde, citral, neral, decanal, vanillin, tolyl aldehyde, 2,6-dimethyloctanal, and 2-ethyl butyraldehyde.

Moreover, solvents may include volatile fragrances, such as natural products and perfume oils. Some representative natural products and perfume oils are ambergris, benzoin, civet, clove, leaf oil, jasmine, mate, mimosa, musk, myrrh, orris, sandalwood oil, and vetivert oil; aroma chemicals, such as amyl salicylate, amyl cinnamic aldehyde, benzyl acetate, citronellol, coumarin, geraniol, isobornyl acetate, ambrette, and terpinyl acetate; and the various classic family perfume oils, such as the floral bouquet family, oriental family, chypre family, woody family, citrus family, canoe family, leather family, spice family, and herbal family.

Other components that may be used to form the organosilane compositions and/or personal care compositions of this disclosure are described in U.S. Pat. Nos. 5,505,937; 6,071,503; 6,074,654; 6,139,823; 6,180,117; 6,967,024; 6,991,782; 7,871,633; 8,557,230; 8,586,013; 8,673,282; 8,603,444; 8,673,283; 8,673,284; 8,758,739; and 8,778,323; US Pub Nos. 2003/0235552; 2009/0036615; and 2012/0171137; JP Pat. App. Nos. 61-161211 and 61-158913; JP Pat. No. 61-18708; EP Pat. No. 0709083; and WO2010/149493 and WO2013/103832; each of which is expressly incorporated herein by reference in one or more non-limiting embodiments.

### Method of Forming the Personal Care Composition:

This disclosure also provides a method of forming the personal care composition. The method includes combining a personal care product or any other similar compound, as described above, with the organosilane composition. In one embodiment, the organosilane composition is prepared individually and then combined later with the personal care composition ingredients. It is possible to include some personal care ingredients at a fluid reaction step (i.e., formation of a hydrosilylation reaction product, if utilized) but various factors may need to be controlled, such as reaction inhibition, temperature sensitivity of the ingredients, etc. Techniques known in the art for formation of personal care formulations, including but not limited to, mixing techniques, cold blends or application of heat to facilitate forming the personal care composition, can be used. The order of addition used herein can be any known in the art.

### EXAMPLES

The following examples are included to demonstrate embodiments of the invention. It should be appreciated by those of skill in the art that the techniques disclosed in the examples which follow represent techniques discovered by the inventors to function well in the practice of the invention, and thus can be considered to constitute modes for its practice. However, those of skill in the art should, in light of the present disclosure, appreciate that many changes can be made in the specific embodiments which are disclosed and still obtain a like or similar result without departing from the spirit and scope of the invention. All percentages are in wt % and all measurements were conducted at 23° C. unless indicated otherwise.

### Comparative Example 1

### Preparation of Poly (EO) Methyl 3-(Methyldiethoxysilyl) Propyl Ether

PG SF-Allyl EO7-Me (463.73 g; UNIOX MUS-4 from NOF Corporation) was loaded in a 2 L 3-necked round-bottomed flask (RBF) fitted with a crescent-shaped paddle stirring rod, a Claisen adaptor itself fitted with a water cooled condenser and a 250 mL additional funnel loaded with methyldiethoxylsilane (136.52 g; from Gelest, Inc), and a thermometer adaptor itself fitted with a thermal couple, all under nitrogen purge. The reaction mixture was heated to 60° C. when 20 wt. % or 28 g of methyldiethoxylsilane was fed in the RBF immediately followed by the addition of 1% Dow Corning® 2-0707 INT catalyst in IPA (˜400 μL or 6 ppm). The exotherm observed instantaneously was 18° C. The remaining methyldiethoxylsilane in the additional funnel was being dispensed into the RBF at ˜1.21 g/min rate while temperature was set at 80° C. and being maintained below 85° C. throughout the addition. The second charge of 1% Dow Corning® 2-0707 INT catalyst in IPA (˜500 μL or 7 ppm) was done after the first hour of silane addition and ˜5° C. exotherm was seen. When all methyldiethoxylsilane was in the RBF, the temperature was set at 85° C. set point and the third addition of 1% Dow Corning® 2-0707 INT catalyst in IPA (-500 pL or 7 ppm) was added while no exotherm was observed. The product mixture was then allowed to reflux for another hour for hydrosilylation completion. Once the reaction was determined to be done, residual SiH was measured by IR which was 34 ppm at peak 2150 cm⁻¹. On the following day, the Claisen adapter was replaced by a water cooled condenser fitted with a 250 mL round-bottomed flask. The set-up was connected to vacuum for stripping. The product mixture was stripped for 1 h under 10-40 mmHg vacuum pressure at 90° C. The final residual SiH content measured by IR was 4 ppm at 2150 cm⁻¹. The final finished product was pressure-filtered on 20 μm sized filter paper.

### Comparative Example 2

### Preparation of Poly (EO) Methyl 3-(Methylditmethoxysilyl) Propyl Ether

PG SF-Allyl EO7-Me (489.378 g; UNIOX MUS-4 from NOF Corporation) was loaded in a 2 L 3-necked round-bottomed flask (RBF) fitted with a crescent-shaped paddle stirring rod, a Claisen adaptor itself fitted with a water cooled condenser and a 250 mL additional funnel loaded with Dow Corning® Z-6701 Silane (110.622 g), and a thermometer adaptor itself fitted with a thermal couple, all under nitrogen purge. The reaction mixture was heated to 45° C. when 10 wt. % or 11 g of Z-6701 silane was fed in the RBF immediately followed by the addition of 1% Dow Corning® 2-0707 INT catalyst in IPA (˜400 μL or 6 ppm). The exotherm observed instantaneously was 2-3° C. The remaining Z-6701 in the additional funnel was being dispensed into the RBF at ˜1.67 g/min rate while temperature set at 53° C. plus 2° C. exotherm was maintained throughout the addition. When all Z-6701 was in the RBF, the temperature of mixture dropped back to the 53° C. set point and hence, there was a second addition of 1% Dow Corning® 2-0707 INT catalyst in IPA (˜500 μL or 7 ppm). The mixture was then held for another 2 h to allow reaction gone for completion in which the third addition of 1% Dow Corning® 2-0707 INT catalyst in IPA (˜500 μL or 7 ppm) were made after the first hour of reflux. A constant 2° C. exotherm was observed after each time the catalyst was added and had lasted for 1 h except for the last addition which lasted only 30 minutes. Once the reaction was determined to be done, residual SiH was measured by IR which was 35 ppm at peak 2150 cm⁻¹. On the following day, the Claisen adapter was replaced by a water cooled condenser fitted with a 250 mL round-bottomed flask. The set-up was connected to vacuum for stripping. The product mixture was stripped for 1 h under 10-20 mmHg vacuum pressure at 60° C. The final residual SiH content measured by IR was 4 ppm at 2150 cm⁻¹. The final finished product was pressure-filtered on 20 μm sized filter paper.

### Comparative Example 3

### Preparation of Poly (EO) Hydroxyl 3-(Methyldiethoxysilyl) Propyl Ether

PG SF-Allyl EO7-OH (191.85 g; from Dow Chemical Company was loaded in a 500 mL 3-necked round-bottomed flask (RBF) fitted with a crescent-shaped paddle stirring rod, a Claisen adaptor itself fitted with a water cooled condenser and a 250 mL additional funnel loaded with methyldiethoxylsilane (58.67 g from Gelest, Inc), and a thermometer adaptor itself fitted with a thermal couple, all under nitrogen purge. The reaction mixture was heated to 60° C. when 10 wt. % or 6 g of methyldiethoxylsilane was dispensed in the RBF immediately followed by the addition of 1% Dow Corning® 2-0707 INT catalyst in IPA (˜230 μL or 8 ppm). The exotherm observed instantaneously was 7° C. The remaining methyldiethoxylsilane in the additional funnel was being dispensed into the RBF at ˜0.88 g/min rate while temperature was set at 67° C. and being maintained at ˜75° C. throughout the addition. When all methyldiethoxylsilane was added to the RBF, the temperature was set at 75° C. to reflux for an hour to allow the reaction to go to completion. The reaction mixture was cooled down to 60° C. and 159 ppm of residual SiH was obtained by IR at peak 2150 cm⁻¹. A second addition of 1% Dow Corning® 2-0707 INT catalyst in IPA (˜50 μL or ˜1.7 ppm) was charged to the reaction mixture, however, no exotherm was detected. The reaction temperature was increased to 80° C. and refluxed for an hour. The residual SiH was measured 126 ppm. On the following day, the product mixture was transferred to a 1 L round-bottomed flask for rotary evaporation. Some material was stripped out while the vacuum pressure was at ˜3-4 mmHg and the water bath was at 80° C. This process lasted for two hour and the final product has 13 ppm of SiH left. The final product was pressure-filtered on 20 μm filter paper.

### Comparative Example 4

### Preparation of Poly (EO) Hydroxyl 3-(Methyldimethoxysilyl) Propyl Ether

PG SF-Allyl EO7-OH (80.58 g; from Dow Chemical Company) was loaded in a 250 mL 3-necked round-bottomed flask (RBF) fitted with a crescent-shaped paddle stirring rod, a Claisen adaptor itself fitted with a water cooled condenser and a 250 mL additional funnel loaded with Dow Corning® Z-6701 Silane (20.06 g), and a thermometer adaptor itself fitted with a thermal couple, all under nitrogen purge. The reaction mixture was heated to 45.6° C. when 10 wt. % or 2 g of Dow Corning® Z-6701 Silane was dispensed in the RBF immediately followed by the addition of 1% Dow Corning® 2-0707 INT catalyst in IPA (˜60 μL or 5 ppm). The exotherm observed instantaneously was 0.9° C. The remaining Dow Corning® Z-6701 Silane in the additional funnel was being dispensed into the RBF at ˜0.21 g/min rate while temperature was set at 50° C. and being maintained at ˜49-51° C. throughout the addition. When all methyldiethoxylsilane was added to the RBF, the temperature was set at 57° C. to reflux for 2.5 hours to allow reaction gone for completion. The reaction mixture was cooled down to room temperature and 121 ppm of residual SiH was obtained by IR at peak 2150 cm⁻¹. On the following day, extra PG SF-Allyl EO7-OH (5.48 g from Dow Chemical Company) was added to the reaction mixture while holding the reaction at 57±1° C. for 4.5 h, resulting in 20 ppm residual SiH. The Claisen adapter was replaced by a water cooled condenser fitted with a 250 mL round-bottomed flask the day after. The set-up was connected to vacuum for stripping. The product mixture was stripped for 3 h under 10-50 mmHg vacuum pressure at 80° C. The final residual SiH content measured by IR was still 20 ppm at 2150 cm⁻¹. The final finished product was pressure-filtered on 20 μm sized filter paper.

### Comparative Example 5

### Preparation of Poly (EO) Acetate 3-(Methyldimethoxysilyl) Propyl Ether

PG SF-Allyl EO7-Ac (247.77 g) was loaded in a 500 mL 3-necked round-bottomed flask (RBF) fitted with a crescent-shaped paddle stirring rod, a Claisen adaptor itself fitted with a water cooled condenser and a 250 mL additional funnel loaded with Dow Corning® Z-6701 Silane (52.98 g), and a thermometer adaptor itself fitted with a thermal couple, all under nitrogen purge. The reaction mixture was heated to 47° C. when 10 wt. % or 5 g of Dow Corning® Z-6701 Silane was dispensed in the RBF immediately followed by the addition of 1% Dow Corning® 2-0707 INT catalyst in IPA (˜270 μL or 8 ppm). The exotherm observed instantaneously was 1-2° C. The remaining Dow Corning® Z-6701 Silane in the additional funnel was being dispensed into the RBF at ˜0.79 g/min rate while temperature was set at 54° C. and being maintained below 58° C. throughout the addition. When all Dow Corning® Z-6701 Silane was added to the RBF, the temperature was set at 54° C. to reflux for an hour to allow reaction gone for completion. 540 ppm of residual SiH was obtained by IR at peak 2150 cm⁻¹. Another hour of reflux was proceeded and the residual SiH was measured 300 ppm. On the following day, the Claisen adapter was replaced by a water cooled condenser fitted with a 250 mL round-bottomed flask. The set-up was connected to vacuum for stripping. The product mixture was stripped for a total of 3 h under 20-80 mmHg vacuum pressure at 62° C. The final residual SiH content measured by IR was 28 ppm at 2150 cm⁻¹. The final finished product was pressure-filtered on 20 μm sized filter paper.

### Comparative Example 6

To a three neck round bottom flask was added 171.8 g (0.29 moles) of a polyether containing an allyl end, approximately 12 ethylene oxide units and capped with acetate. Next, 28.2 g (0.21 moles) of methyl diethoxy silane (MDES) was added to the flask. With stirring under N₂, the mixture was heated to 75°±5° C. and then 3 ppm of Pt catalyst was added. After a small exotherm (<10°±1° C.) the mixture was maintained at 85°±5° C. for 6 hours. At this point the reaction was 98.9% complete as measured by SiH consumption via FTIR. The mixture was stripped of volatiles by heating to 120°±5° C./5-10 mmHg for 4 hours. Finally, the mixture was cooled to room temperature and filtered through Celite that was supported on a Nylon filter to yield 167 g (83% yield) of a light yellow oil. Characterization of this material indicated that the desired product had been obtained as evidenced by the single peak in the ²⁹Si NMR at approximately −5.6 ppm.

### Comparative Example 7

To a three neck round bottom flask was added 189.3 g (97 mmoles) of a polyether containing an allyl end, approximately 18 ethylene oxide units and 18 propylene oxide units and capped with acetate. Next, 10.9 g (81 moles) of methyl diethoxy silane (MDES) was added to the flask. With stirring under N₂, the mixture was heated to 75°±5° C. and then 4 ppm of Pt catalyst was added. After a small exotherm (<10°±1° C.) the mixture was maintained at 85°±5° C. for 3 hours. At this point the reaction was 99.6% complete as measured by SiH consumption via FTIR. The mixture was stripped of volatiles by heating to 120°±5° C./5-10 mmHg for 5 hours. Finally, the mixture was cooled to room temperature and filtered through Celite that was supported on a Nylon filter to yield 153 g (76% yield) of a light yellow oil. Characterization of this material indicated that the desired product had been obtained as evidenced by the single peak in the ²⁹Si NMR at approximately −5.6 ppm.

### Comparative Example 8

To a three neck round bottom flask was added 168.7 g (0.31 moles) of a polyether containing an allyl end, approximately 12 ethylene oxide units and was not capped. Next, 31.4 g (0.24 moles) of methyl diethoxy silane (MDES) was added to the flask. With stirring under N₂, the mixture was heated to 75°±5° C. and then 3 ppm of Pt catalyst was added. After a small exotherm (<10°±1° C.) the mixture was maintained at 85°±5° C. for 3 hours. At this point the reaction was 99.5% complete as measured by SiH consumption via FTIR. The mixture was stripped of volatiles by heating to 120°±5° C./5-10 mmHg for 4 hours. Finally, the mixture was cooled to room temperature and filtered through Celite that was supported on a Nylon filter to yield 149 g (74% yield) of a light yellow oil. Characterization of this material indicated that the desired product had been obtained as evidenced by the single peak in the ²⁹Si NMR at approximately −5.6 ppm.

### Invention Example 1

To a 500 ml three neck round bottom flask was added 188.9 g (98.2 mmoles) of a polyether that contains 18 ethylene oxide units, 18 propylene oxide units and is capped with a 3,3-dimethyl-1-propenyl group on one end. The polyether is heated to 40°±3° C. and approximately 5% of total volume of methyldimethoxysilane is added (total volume is 15.7 g, 148 mmoles) to the reaction vessel via an addition funnel. Next, platinum catalyst is added so that the final concentration is 5 ppm in the final mixture, and an exotherm is observed. After the exotherm is complete the remaining methyldimethoxysilane is added from the addition funnel at a rate so that the temperature of the mixture remains below 50° C. Upon the addition of all the methyldimethoxysilane, the reaction vessel is maintained at 50°±3° C. for 3 hours. Next, the volatiles are removed from the product by increasing the flow of N₂ through the reaction vessel. A low viscosity liquid is obtained. Analysis by ¹H, ¹³C, ²⁹Si NMR and FTIR confirms that the desired material has prepared and the level of unreacted polyether is less than 1% on a molar basis and no residual SiH is present.

### Invention Example 2

To a 500 ml three neck round bottom flask was added 93.1 g (98.0 mmoles) of a polyether that contains 6 ethylene oxide units, 11 propylene oxide units and is capped with a 2-methyl-1-propenyl group on one end. The polyether is heated to 40°±3° C. and approximately 5% of total volume of methyldimethoxysilane is added (total volume is 15.7 g, 148 mmoles) to the reaction vessel via an addition funnel. Next, platinum catalyst is added so that the final concentration is 5 ppm in the final mixture, and an exotherm is observed. After the exotherm is complete the remaining methyldimethoxysilane is added from the addition funnel at a rate so that the temperature of the mixture remains below 50° C. Upon the addition of all the methyldimethoxysilane, the reaction vessel is maintained at 50°±3° C. for 3 hours. Next, the volatiles are removed from the product by increasing the flow of N₂ through the reaction vessel. A low viscosity liquid is obtained. Analysis by ¹H, ¹³C, ²⁹Si NMR and FTIR confirms that the desired material was prepared and the level of unreacted polyether is less than 1% on a molar basis and no residual SiH is present.

### Invention Example 3

To a 500 ml three neck round bottom flask was added 59.4 g (97.3 mmoles) of a polyether that contains 11 ethylene oxide units and is capped with a 2-methyl-1-propenyl group on one end. The polyether is heated to 40°±3° C. and approximately 5% of total volume of methyldimethoxysilane is added (total volume is 15.7 g, 148 mmoles) to the reaction vessel via an addition funnel. Next, platinum catalyst is added so that the final concentration is 5 ppm in the final mixture, and an exotherm is observed. After the exotherm is complete the remaining methyldimethoxysilane is added from the addition funnel at a rate so that the temperature of the mixture remains below 50° C. Upon the addition of all the methyldimethoxysilane, the reaction vessel is maintained at 50°±3° C. for 3 hours. Next, the volatiles are removed from the product by increasing the flow of N₂ through the reaction vessel. A low viscosity liquid is obtained. Analysis by ¹H, ¹³C, ²⁹Si NMR and FTIR confirms that the desired material was prepared and the level of unreacted polyether is less than 1% on a molar basis and no residual SiH is present.

The terms “comprising” or “comprise” are used herein in their broadest sense to mean and encompass the notions of “including”, “include”, “consist(ing) essentially of”, and “consist(ing) of”. The use of “for example”, “e.g.”, “such as”, and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-10, ±0-5, or ±0-2.5, % of the numerical values. Further, The term “about” applies to both numerical values when associated with a range of values. Moreover, the term “about” may apply to numerical values even when not explicitly stated.

The term “ambient temperature” or “room temperature” as used herein refers to a temperature of from about 20-30, ° C. Usually, “room temperature” ranges from about 20-25, ° C. All viscosity measurements referred to herein were measured at 25° C. unless otherwise indicated. Generally, as used herein a hyphen “-” or dash “—” in a range of values is “to” or “through”; a “>” is “above” or “greater-than”; a “≧” is “at least” or “greater-than or equal to”; a “<” is “below” or “less-than”; and a “≦” is “at most” or “less-than or equal to”.

The term “branched” as used herein describes a polymer with >2 end groups. The term “substituted” as used in relation to another group, for example, a hydrocarbon group, means, unless indicated otherwise, one or more hydrogen atoms in the hydrocarbon group has been replaced with another substituent. Examples of such substituents include, but are not limited to, halogen atoms, such as chlorine, fluorine, bromine, and iodine; halogen atom containing groups, such as chloromethyl, perfluorobutyl, trifluoroethyl, and nonafluorohexyl; oxygen atoms; oxygen atom containing groups, such as (meth)acrylic and carboxyl; nitrogen atoms; nitrogen atom containing groups, such as amines, amino-functional groups, amido-functional groups, and cyano-functional groups; sulphur atoms; and sulphur atom containing groups, such as mercapto groups.

On an individual basis, each of the aforementioned applications for patent, patents, and/or patent application publications, is expressly incorporated herein by reference in its entirety in one or more non-limiting embodiments.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present invention has been described herein in an illustrative manner, and it is to be understood that the terminology which has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

What is claimed is:

1. A process for preparing an organosilane, said process comprising reacting:
a) an organosilane of the formula (R¹)₍₃₋ₙ₎(R²O)ₙSiH,
where R¹ is a hydrocarbon group containing 1 to 12 carbon atoms,
R² is hydrogen or an alkyl group containing 1 to 6 carbon atoms, and
“n” is 1 or 2; and
b) a polyoxyalkylene of the formula R⁵O(CH₂CH₂O)ₐ(C₃H₆O)_{b}R⁴,
where a≧1, “b” may vary from 0 to 30, with the proviso a≧b,
R⁴ is hydrogen, R¹, or an acetyl group, and
R⁵ is an unsaturated aliphatic hydrocarbon group selected from H₂C═CHC(CH₃)₂—,
HC≡CC(CH₃)₂—, and HC≡CC(CH₃)₂CH₂—;
in the presence of
c) a hydrosilylation catalyst.

2. The process of claim 1, wherein R⁵ is H₂C═CHC(CH₃)₂—.

3. The process of claim 1, wherein the organosilane has the formula (CH₃)(CH₃CH₂O)₂SiH.

4. An organosilane prepared in accordance with the method of claim 1.

5. An organosilane composition comprising the organosilane of claim 4.

6. A treatment composition comprising a reaction product of the organosilane according to claim 4.

7. The treatment composition of claim 6, wherein the reaction product of the organosilane comprises a hydrolysis and/or condensation reaction product.

8. A composition comprising an organosilane having the formula:
(R¹)₍₃₋ₙ₎(R²O)ₙSiR³O(CH₂CH₂O)ₐ(C₃H₆O)_{b}R⁴
where “n” is 1 or 2,
a≧1, “b” may vary from 0 to 30, with the proviso a≧b,
R¹ is a hydrocarbon group containing 1 to 12 carbon atoms,
R² is hydrogen or an alkyl group containing 1 to 6 carbon atoms,
R³ is a divalent hydrocarbon group containing 2 to 12 carbon atoms, and
R⁴ is hydrogen, R¹, or an acetyl group.

9. The composition of claim 8, where “n” is 2.

10. The composition of claim 8, where “a” ranges from 4 to 30.

11. The composition of claim 8, where R¹ is methyl and each R² is independently methyl or ethyl.

12. The composition of claim 8, where the organosilane has the average formula (CH₃)(CH₃O)₂SiCH₂CH₂C(CH₃)₂O(C₂H₄O)₁₈(C₃H₆O)₁₈H.

13. A method of treating a surface comprising applying the composition according to claim 8 to a surface.

14. The method of claim 13, where the surface is a cellulosic fiber.

15. An article of manufacture comprising the treated fiber of claim 14.

16. A process for preparing an organosilane composition, said process comprising reacting:
a) an organosilane of the formula (R¹)₍₃₋ₙ₎(R²O)ₙSiH,
where R¹ is a hydrocarbon group containing 1 to 12 carbon atoms,
R² is hydrogen or an alkyl group containing 1 to 6 carbon atoms, and
“n” is 1, 2 or 3; and
b) a polyoxyalkylene of the formula R⁵O(CH₂CH₂O)ₐ(C₃H₆O)_{b}R⁴
where a≧0, b≧0, with the proviso (a+b)≧1,
R⁴ is hydrogen, R¹, or an acetyl group, and
R⁵ is an a hydrocarbon group including a terminal allylic unsaturated group;
in the presence of
c) a hydrosilylation catalyst;
wherein
i) a gamma carbon atom of R⁵ includes two independently selected hydrocarbyl groups bonded thereto; and/or
ii) a beta carbon atom of R⁵ includes a hydrocarbyl group bonded thereto.

17. The process of claim 16, wherein a gamma carbon atom of R⁵ includes two independently selected hydrocarbyl groups bonded thereto, alternatively where R⁵ is H₂C═CHC(CH₃)₂—.

18. The process of claim 16, wherein a beta carbon atom of R⁵ includes a hydrocarbyl group bonded thereto, alternatively where R⁵ is H₂C═C(CH₃)CH₂—.

19. The process of claim 16, where:
i) a≧1 and “b” may vary from 0 to 30; and/or
ii) a≧b.

20. The process of claim 16, where:
i) “a” may vary from 0 to 30 and b≧1; and/or
ii) b≧a.
